(19) United States
(12) Patent Application Publication
(10) Pub. No.: US 2013/0108929 A1
(43) Pub. Date: May 2, 2013

(54) LITHIUM-TITANIUM COMPLEX OXIDE AND MANUFACTURING METHOD THEREOF, AS WELL AS BATTERY ELECTRODE AND LITHIUM ION SECONDARY BATTERY USING THE SAME

(71) Applicant: TAIYO YUDEN CO., LTD., Tokyo (JP)

(72) Inventors: Daigo ITO, Takasaki-shi (JP); Chie KAWAMURA, Takasaki-shi (JP); Masaki MOCHIGI, Takasaki-shi (JP); Akitoshi WAGAWA, Takasaki-shi (JP); Toshiyuki OCHIAI, Takasaki-shi (JP); Isao TAKAHASHI, Takasaki-shi (JP); Yoichiro OGATA, Takasaki-shi (JP); Toshimasa SUZUKI, Takasaki-shi (JP)

(73) Assignee: TAIYO YUDEN CO., LTD., Tokyo (JP)

(21) Appl. No.: 13/625,689

(22) Filed: Sep. 24, 2012

(30) Foreign Application Priority Data
Oct. 26, 2011 (JP) 2011-235219

(51) Int. Cl. H01M 4/485; C01D 15/02

(52) U.S. Cl. 429/231.5; 423/598

(57) ABSTRACT

A lithium-titanium complex oxide, which exhibits high effective capacity and high rate characteristics, has a particle size distribution as measured by the laser diffraction method such that the maximum particle size (D100) is 20 μm or less, average particle size D50 is 1.0 to 1.5 μm, total frequency of particles whose particle size is greater than twice the average particle size D50 is 16 to 25%, and preferably the specific surface area as measured by the BET method is 6 to 14 m²/g, and preferably the angle of repose is 35 to 50°.

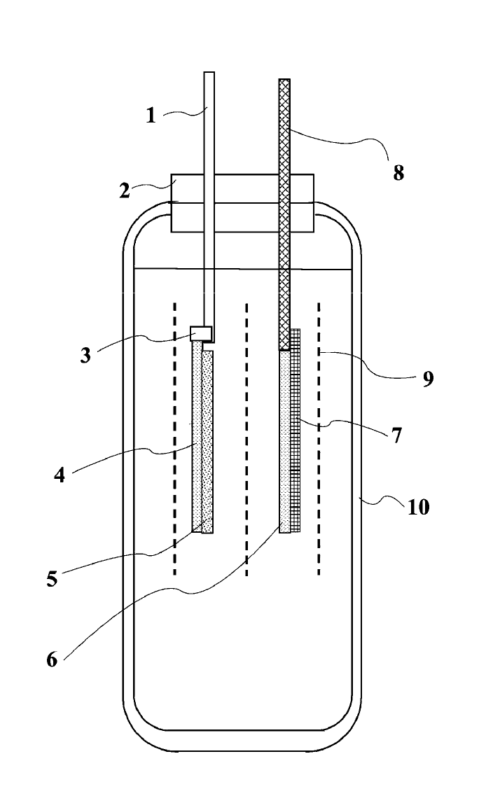

### BACKGROUND

1. Field of the Invention

The present invention relates to a lithium-titanium complex oxide suitable as an electrode material for lithium ion secondary battery, as well as a manufacturing method thereof

Development of lithium ion secondary batteries as high-capacity energy devices has been active in recent years, and lithium ion secondary batteries are beginning to be utilized in consumer equipment, industrial machinery, automobiles, and various other fields. Characteristics required of lithium ion secondary batteries include high energy density, high power density, and other characteristics that support high capacity and allow for quick charge/discharge. On the other hand, incidents of fire involving lithium ion secondary batteries have been reported and the market is demanding greater safety of lithium ion secondary batteries. In particular, lithium ion secondary batteries used in onboard applications, medical applications, etc., directly affect human life in case of accidents, and require even greater safety. Safety is also required of materials used for lithium ion secondary batteries, where, specifically, the market is demanding materials that demonstrate stable charge/discharge behaviors and will not burst into flame or ignite even in unforeseen accidents.

Lithium titanates include those expressed by Li₄Ti₅O₁₂, Li_{4/3}Ti_{5/3}O₄ and Li[Li_{1/6}Ti_{5/6}]₂O₄, for example. Among these, Li₄Ti₅O₁₂ is a lithium titanate having a spinel crystalline structure. This lithium titanate changes to a rock-salt crystalline structure as lithium ions are inserted during charge, and changes back to a spinel crystalline structure as lithium ions dissociate. The lithium titanate undergoes far less change in its lattice volume due to charge/discharge compared to carbon materials that are conventional materials for negative electrodes, and generates little heat even when shorted to the positive electrode, thereby preventing fire accidents and ensuring high safety. Lithium-titanium complex oxides whose main constituent is lithium titanate and to which trace constituents have been added as necessary, are beginning to be adopted by lithium ion secondary battery products that are designed with specific focus on safety.

Tap density of powder, which is traditionally evaluated as one general powder property required of battery materials including lithium-titanium complex oxides, is an important factor that affects handling of powder and becomes particularly useful when the sizes of primary particles constituting the powder are relatively large in a range of several μm to several tens of μm or when an electrode coating film is formed directly from the granulated powder. On the other hand, powder properties of lithium ion secondary battery materials are drawing renewed attention in recent years in order to support the high-performance needs of lithium ion secondary batteries, and as part of this trend, attempts are being made to reduce the primary particle size of powder. This is an important factor that affects quick charge/discharge (rate characteristics) as the smaller the particle size, the smoother the insertion/dissociation reactions of lithium ions become and good characteristics are achieved as a result.

Methods to make the particles constituting the powder finer include the method to use the liquid phase method to make the primary particles themselves fine (build-up method) as described in Patent Literature 1, and the method to crush the primary particles after giving them a relatively rough heat treatment to make them finer (breakdown method) as described in Example 1 of Patent Literature 2. There is also a method, which is not the liquid phase method, whereby a very fine titanium compound is used as the material and mixed with a lithium compound, and then the mixture is heat-treated at low temperature to manufacture fine lithium titanate particles. Patent Literature 3 touches on the particle size distribution measured by laser diffraction and reports that the particle size distribution has positive impact on rate characteristics.

### BACKGROUND ART LITERATURES

[Patent Literature 1] Japanese Patent No. 3894614

[Patent Literature 2] Japanese Patent Laid-open No. 2002-289194

[Patent Literature 3] Japanese Patent No. 4153192

### SUMMARY

Patent Literatures 1 and 2 each describe a powder design that allows for easy handling in a specific application, but neither discloses a clear powder design method for effectively handling fine particles. Patent Literature 3 stops at disclosing the particle size distribution in the forms of average size and distribution band of secondary particles, but this information alone does not clearly reveal the average size and distribution band of primary particles. There is no mention of properties of coating solution and coating film, either. Here, it should be noted that the primary particle size and secondary particle size are differentiated. Furthermore, the primary particle size distribution and secondary particle size distribution can each be an equally important factor. The primary particle refers to the smallest unit of particle constituting the powder, while the secondary particle refers to an aggregate formed by a group of primary particles.

If the particle size is too small, the ease of handling is affected, for example, dispersion becomes difficult when preparing an electrode coating solution or the like. If an electrode coating film is formed from fine particles, the electrode density cannot be raised, unlike when it is formed from large particles as has been done traditionally. This is because, when an electrode coating solution is prepared, fine particles do not disperse stably in the dispersion medium and end up forming a three-dimensional cross-linked structure. When large particles are used, the tap filling property of the powder is somewhat correlated with the density of the coating film, but when fine particles are used, the wettability on the particle surface and affinity with the dispersion medium tend to drop in the coating solution, and cohesion and formation of cross-linked structure occur easily as a result, which is different from the tap filling property exhibited by the powder. If an electrode coating film is formed using the above coating solution, the coating film density drops and consequently the energy density of the resulting lithium ion secondary battery becomes lower and other problems may also occur such as drop in reliability due to separation of the film. To prevent these problems, additives such as a large amount of binder and the like must be used. It is important to properly handle a powder made of fine particles that tend to exhibit good rate characteristics, by using the same amount of binder as before.

In addition, superfine particles whose particle size distribution as measured by laser diffraction is 0.2 μm or less are generally difficult to trap due partly to problems regarding the measurement principles and partly to the fact that these particles cohere relatively easily in the dispersion medium, where the tendency is that the finer the overall particle size, the lower the reliability becomes. In other words, fine particles whose average particle size is 1 μm or less cannot clearly express, through powder evaluation by laser diffraction measurement alone, the powder properties needed to exhibit optimal battery characteristics. Prior arts do not present any powder design that optimizes the dispersion stability in the electrode coating solution, ease of handling, and electrode coating film density, while most benefiting the battery characteristics such as rate characteristics and the like at the same time.

In consideration of the above, an object of the present invention is to provide a lithium titanate that can be manufactured by the solid phase method associated with low manufacturing cost, allows for use of fine particles, facilitates management in the manufacturing process, and exhibits high effective capacity and high rate characteristics.

Any discussion of problems and solutions involved in the related art has been included in this disclosure solely for the purposes of providing a context for the present invention, and should not be taken as an admission that any or all of the discussion were known at the time the invention was made.

After studying in earnest, the inventors completed the following invention.

The lithium-titanium complex oxide proposed by the present invention has a particle size distribution of 1.0 to 1.5 μm in average particle size D50 as measured by laser diffraction, where the total frequency of particles whose particle size is greater than twice the average particle size D50 is 16 to 25%, maximum particle size (D100) is 20 μm or less, and preferably the specific surface area as measured by the BET method is 6 to 14 m²/g, and more preferably the angle of repose is 35 to 50°.

According to the manufacturing method of lithium-titanium complex oxide proposed by the present invention, a mixture of titanium compound and lithium compound is heat-treated at 700° C. or above to obtain a lithium-titanium complex oxide, after which 100 parts by weight of the obtained lithium-titanium complex oxide powder is crushed in the presence of 10 parts by weight or less of dispersion medium to increase the specific surface area of the lithium-titanium complex oxide by 5.0 m²/g or more, and preferably the lithium-titanium complex oxide is heat-treated again to decrease its specific surface area by 0.5 to 6.0 m²/g.

According to the present invention, a battery electrode using the aforementioned lithium-titanium complex oxide is also provided, as well as a lithium ion secondary battery having such electrode.

According to the present invention, the average particle sizes of both primary and secondary particles can be reduced by dry crushing, without having to convert the lithium-titanium complex oxide obtained by heat treatment into a slurry. At this time, the primary particle size can be reduced by over-crushing the lithium-titanium complex oxide to some extent, and potential re-cohesion is controlled to control the amount of fine particles and size distribution of secondary particles. Thus obtained, the lithium-titanium complex oxide proposed by the present invention has sufficiently fine primary particles and therefore tends to express desired rate characteristics. In addition, its viscosity can be kept sufficiently low to allow for coating, even if the primary particle size is fine and even if the amount of dispersion medium used in the prepared electrode coating solution is small, with the coating film formed by the coating solution having high density and also offering high separation strength without having to increase the amount of binder.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawing of a preferred embodiment which is intended to illustrate and not to limit the invention. The drawing is greatly simplified for illustrative purposes and are not necessarily to scale.

The FIGURE is a schematic section view of a half cell.

### DESCRIPTION OF THE SYMBOLS

1 Al lead

2 Thermo-compression bonding tape

3 Kapton tape

4 Aluminum foil

5, 15, 16 Electrode mixture

6 Metal Li plate

7 Ni mesh

8 Ni lead

9 Separator

10 Aluminum laminate cell

### DETAILED DESCRIPTION OF EMBODIMENTS

According to the present invention, a ceramic material whose main constituent is a lithium titanate having a spinel structure expressed by Li₄Ti₅O₁₂ and to which trace constituents have been added as necessary is provided, and this ceramic material contains the aforementioned lithium titanate typically by 90% or more, or preferably 95% or more. In this Specification, this ceramic material is sometimes referred to as “lithium-titanium complex oxide.” According to the present invention, the lithium-titanium complex oxide is in a powder form as an aggregate of particles whose shape (particle size distribution, etc.) is explained in detail below. According to the present invention, the lithium-titanium complex oxide can contain elements other than titanium, lithium and oxygen, where examples of the elements that can be contained include potassium, phosphorous, niobium, sulfur, silicon, zirconium, calcium, and sodium, etc. Preferably these constituents are virtually all dissolved in the ceramic structure of lithium titanate as oxides.

The inventors revealed detailed conditions for particle size distribution and optimal cohesion level as factors that affect the battery characteristics. According to the present invention, the average value (D50) and maximum value (D100) of secondary particle size are important. This is because the overall range of particle size distributions affects the battery characteristics most. D50 is the simplest evaluation standard based on which to understand the basic fineness of particles, where the range of D50 in which good battery characteristics are obtained is 0.5 to 1.5 μm. Based on a new insight gained by the inventors, however, cases of deteriorated battery characteristics have been confirmed even at a D50 of 0.5 to 1.0 μm based on laser diffraction measurement. This may be explained by the existence of too many very fine particles. In general, the finer the particle size, the more unstable the coating solution becomes, and the electrode density of the formed coating film drops as a result. In this case, the battery characteristics are good initially, but will deteriorate significantly over time through repeated charge/discharge cycles. Accordingly, it is important for D50 to be not too small in order to express an optimal powder design by laser diffraction measurement alone, and it is best that D50 be 1 μm or more. In other words, a particle size distribution where D50 is less than 1 μm makes it difficult to make accurate judgment by laser diffraction measurement alone, and combination of another evaluation method becomes desirable. Under the present invention, therefore, D50 as measured by laser diffraction measurement must be in a range of 1.0 to 1.5 μm.

Methods to increase D50 include growing the particle by raising the temperature of the heat treatment given to synthesize the lithium-titanium complex oxide (primarily increasing the primary particle size), or adding a cohesion operation after heat-treating and synthesizing the lithium-titanium complex oxide (primarily increasing the secondary particle size), etc, while methods to decrease D50 include suppressing the particle growth by lowering the temperature of the heat treatment at the time of synthesis (primarily decreasing the primary particle size), or adding a crushing operation after heat-treating and synthesizing the lithium-titanium complex oxide (primarily decreasing the secondary particle size), etc.

To determine the factors benefiting the battery characteristics in a comprehensive manner, knowing D50 alone is not enough. Since D100 represents the coarsest secondary particle size, this information is important in knowing the range of particle sizes. According to the present invention, D100 is 20 μm or less. Based on a new insight gained by the inventors, it is effective to specify the amount of relatively coarse particles with respect to D50 and the amount of relatively fine particles with respect to D50, in addition to specifying D50 and D100. Methods to increase D100 include adding a cohesion operation after synthesizing the lithium-titanium complex oxide, or forming necking by giving heat treatment again, etc. Methods to decrease D100 include adding a crushing operation or classification operation after synthesizing the lithium-titanium complex oxide, etc.

It became clear that, according to the present invention, the amount of particles having a relatively large particle size with respect to D50 could be a factor affecting the properties of the electrode coating solution and coating film. In other words, it is now possible to achieve good electrode coating solution and coating film properties without compromising on rate characteristics, by adjusting the total frequency of particles whose particle size is at least twice the value of D50, to a range of 16 to 25% of all particles. If the frequency of particles whose particle size is at least twice the value of D50 is 25% of all particles in the lithium-titanium complex oxide or more, a uniform coating film cannot be obtained easily or rate characteristics and other battery characteristics may deteriorate. Reasons why such large particles are generated include over-cohesion and presence of coarse primary particles. In the case of over-cohesion, rate characteristics, etc., do not deteriorate much, but electrode coating film properties deteriorate, levels of film separation and capacity variation increase, and charge/discharge cycle characteristics deteriorate. If there are many coarse primary particles, rate characteristics deteriorate significantly. Also, if the frequency of particles whose particle size is at least twice the value of D50 is less than 16% of all particles, rate characteristics do not change much, but the film strength of the formed coating film drops. Also, the amounts of dispersion medium and binder needed to prepare the coating solution increase. Methods to increase the frequency of particles whose particle size is at least twice the value of D50 include adding a cohesion operation after heat-treating and synthesizing the lithium-titanium complex oxide, or forming necking by adding heat treatment again, while methods to decrease this frequency include adding a crushing operation or classification operation after heat-treating and synthesizing the lithium-titanium complex oxide.

According to the present invention, preferably the specific surface area measured by the BET (Brunauer-Emmett-Teller) method is 6 to 14 m²/g, and more preferably 6 to 12 m²/g. The value of specific surface area by the BET method is chiefly due to the primary particle size. One reason explaining the presence of particles of large specific surface areas, or specifically very fine particles, is excessive crushing of primary particles in the lithium-titanium complex oxide when the lithium-titanium complex oxide is crushed after synthesis. Although the specific condition varies depending on the heat treatment temperature and materials, the synthesized lithium-titanium complex oxide is sometimes strongly cohered due to heat treatment, and it is important to release this cohesion in the crushing process in order to achieve ease of handling when forming a battery electrode. According to the present invention, the increase in specific surface area due to crushing is preferably 5 m²/g or more, or more preferably 7 m²/g or more, for the lithium-titanium complex oxide whose particle size distribution is 1 μm or more based on D50. Additionally, after the lithium-titanium complex oxide has been synthesized by heat treatment, the specific surface area is kept to preferably 1 m²/g or more, or more preferably 1.5 m²/g or more, in order to reduce the load in the subsequent crushing process and achieve good rate characteristics and other battery performance.

Furthermore, preferably some degree of cohesion is designed into crushing, where adding heat treatment again after crushing is desired in order to retain the cohered form to some extent. The heat treatment temperature is generally in a range of 300 to 700° C., which is lower than the heat treatment temperature for synthesis, but other temperatures may be set as deemed appropriate based on the powder. As a rough guide, the decrease in specific surface area by heat treatment provides a judgment criterion, where the decrease is preferably 0.5 to 6.0 m²/g, or more preferably 1.0 to 5.0 m²/g. These ranges are set because they can achieve an appropriate level of cross-necking (interparticle bonding) of particles, not too much or not too little.

According to the present invention, therefore, the BET specific surface area of the finally obtained lithium-titanium complex oxide is preferably 6 to 14 m²/g, or more preferably 7 to 13 m²/g, or yet more preferably 8 to 12 m²/g. According to the present invention, a key point of design is to cause particles of relatively large secondary particle sizes to be present at a specified frequency. The best mode is where fine primary particles are cohered to some extent and where the percentage accounted for by this aggregate is not too high. In other words, by causing groups of secondary particles to be present beforehand, they can be stably dispersed in the coating solution dispersion medium by keeping the amounts of required dispersion medium and binder low, and the coating film obtained from the resulting coating solution exhibits high density and high strength. This can be explained by the aggregate reinforcing the coating film by acting like a filler on the macro-level. The balance of secondary particle size and primary particle size is also important, where if the secondary particle size is too large, the coating film thickness cannot be reduced and surface smoothness deteriorates, too. If the primary particles are too small, controlling the formation of aggregate becomes difficult. It is important to control the balance of primary size and secondary size and if too many fine particles are produced as a result of crushing the primary particles too fine, implementing proper controls in the powder state and preparation of coating solution becomes difficult.

In addition, the angle of repose is important in ensuring ease of handling when convenience in actual applications is considered. The angle of repose refers to the angle formed by the plane and ridgeline of powder when the powder is deposited on the plane. Under the present invention, the angle of repose measured according to the angle-of-repose measurement method specified in JIS R9301-2-2: 1999 is preferably 30 to 50°, or more preferably 35 to 50°. A powder having an angle of repose in these ranges is easy to handle as it does not clog easily and maintains appropriate flowability. Processes to increase the angle of repose include reducing the particle size via crushing, narrowing the particle size distribution band via classification operation, and giving the secondary particles an irregular form, etc, while processes to decrease the angle of repose include increasing the particle size and widening the particle size distribution band via cohesion operation, and making the secondary particles spherical, etc.

The method to manufacture the lithium-titanium complex oxide proposed by the present invention is not specifically limited, and the favorable example given below is only an example. The lithium-titanium complex oxide is generally manufactured through a step to mix the materials uniformly, a step to heat-treat the obtained mixture, and a step to crush the lithium-titanium complex oxide obtained by heat treatment if it is coarse.

Under the solid phase method, lithium-titanium complex oxide is typically obtained by mixing and sintering a titanium compound, lithium compound, and trace constituents, as necessary.

For the lithium source, a lithium salt or lithium hydroxide is typically used. Examples of the lithium salt include a carbonate and acetate, etc. As a hydroxide, it may be a hydrate such as monohydrate or the like. For the lithium source, two or more of the foregoing may be combined. As other lithium materials, lithium compounds that are generally readily available can be used as deemed appropriate. If residues of substances originating from the lithium compound cannot be permitted in the heat treatment process, it is safe to avoid lithium compounds containing elements other than C, H and O. For the titanium source, a titanium dioxide or hydrous titanium oxide can be applied. A lithium compound is mixed with a titanium compound by the wet method or dry method so that the mol ratio of Li and Ti preferably becomes 4:5. It should be noted that, since lithium may decrease as a result of partial volatilization, loss due to sticking to equipment walls, or for other reasons in the manufacturing process, it may use a greater amount of source lithium than the final target amount of Li.

Wet mixing is a method whereby dispersion medium such as water, ethanol or the like is used together with a ball mill, planetary ball mill, bead mill, wet jet mill, etc. Dry mixing is a method whereby no dispersion medium is used and a ball mill, planetary ball mill, bead mill, jet mill or flow-type mixer, or Nobilta (Hosokawa Micron), Miralo (Nara Machinery), or other machine capable of applying compressive force or shearing force to achieve precision mixing or efficiently add mechano-chemical effect, is used, etc.

The mixed materials are heat-treated in an atmosphere, dry air, nitrogen, argon or other atmosphere at 700° C. or above, or preferably at 750 to 950° C., to obtain a lithium-titanium complex oxide. The specific heat treatment temperature changes as deemed appropriate according to the particle sizes and mixing level of materials as well as the target particle size of the lithium-titanium complex oxide.

In general, a lithium-titanium complex oxide obtained through heat treatment at 700° C. or above has relatively large primary particles and often its primary particles are cohered together. In this case, particle properties in optimal ranges can be achieved easily when relatively high energy is given during the crushing process. Such lithium-titanium complex oxide before crushing has a specific surface area of preferably 0.5 to 5 m²/g, or more preferably 1 to 3 m²/g. The value of this specific surface area can be lowered by raising the heat treatment temperature or extending the heat treatment time. The value of specific surface area can be raised by lowering the heat treatment temperature or shortening the heat treatment time to the extent that the synthetic reaction of lithium-titanium complex oxide still takes place. Optimal particles can be obtained easily by adjusting the increase in specific surface area after crushing to 5.0 m²/g or more, or preferably within a range of 6.0 to 13.0 m²/g. Preferably 100 parts by weight of the lithium-titanium complex oxide obtained through the aforementioned heat treatment is crushed in the presence of 10 parts by weight or less of dispersion medium. The value of specific surface area after crushing can be raised by extending the crushing time, or it can be lowered by shortening the crushing time.

Next, cohesion is preferably designed. The approach here is to add a cohesion process under specific conditions after crushing the lithium-titanium complex oxide and designing its primary particles and secondary particles fine. Methods used for the cohesion process include partially necking the particles via heat treatment at approx. 300 to 700° C., temperatures lower than the range used in the heat treatment for synthesizing the lithium-titanium complex oxide (hereinafter also referred to as the “second heat treatment”), or promoting cross-attachment/cohesion of powder particles using any of various powder processing apparatuses, etc.

To achieve cohesion at the time of crushing in a powder treatment apparatus, achieving a proper cohesion design is difficult if a jet mill or other apparatus where the powder does not easily make direct contact with the apparatus is used, and apparatus having a classification mechanism such as a classification rotor and the like are not suitable. However, this is not the case if a re-cohesion step is provided after crushing. In addition, an organic solvent etc. offers the effect of promoting crushing as an additive auxiliary and can also be used as a cohesion agent for partially cohering the powder. For example, it is possible to maintain an aggregate of a certain size or smaller, even when a powder equipment aimed at crushing through a grinding process, etc., is used, by effectively utilizing auxiliaries. The particle size of the aggregate changes depending on the types of auxiliaries. However, desirably the additive quantities of auxiliaries are kept to 10 percent by weight or less, or preferably 5 percent by weight or less, or more preferably 2 percent by weight or less, relative to the powder. Effects of auxiliaries include improving the powder crushing efficiency and forming an aggregate. In particular, their aggregate-forming effect is very important in achieving an optimal powder design. The best mode of the present invention is achieved by combining the above powder crushing process, aggregate-formation process and low-temperature heat treatment (second heat treatment). By adjusting the particle size distribution of the powder following the synthesis of lithium-titanium complex oxide and then heat-treating again the powder whose particle size distribution has thus been adjusted, separation can be minimized when a coating solution is prepared, coating film is formed or pressed, etc., and also the powder can be handled easily without causing its particle size distribution to change even when the powder receives compressive stress due to its dead weight inside a flexible bulk container during transit.

When the second heat treatment is given, the specific surface area of the lithium-titanium complex oxide to be heat-treated again is preferably 7 to 18 m²/g, or more preferably 8 to 15 m²/g. The value of specific surface area after the second heat treatment can be lowered by raising the temperature of the second heat treatment or extending the heat treatment time. To raise the value of specific surface area, the temperature of the second heat treatment can be lowered or second heat treatment time can be shortened. The decrease in the specific surface area of the lithium-titanium complex oxide due to second heat treatment is preferably 0.5 to 6.0 m²/g.

Although the solid phase method discussed above is advantageous in terms of cost among the manufacturing methods for lithium-titanium complex oxide, the sol-gel method or wet method using alkoxide can also be adopted.

The lithium-titanium complex oxide proposed by the present invention can be used favorably as an active electrode material for lithium ion secondary batteries. It can be used for positive electrodes or negative electrodes. The configurations and manufacturing methods of electrodes containing the lithium-titanium complex oxide as their active material and lithium ion secondary battery having such electrodes can apply any prior technology as deemed appropriate. Also in the examples explained later, an example of manufacturing a lithium ion secondary battery is presented. Typically an electrode coating solution containing the lithium-titanium complex oxide as an active material, conductive auxiliary, binder, and solvent is prepared, and this electrode coating solution is applied to the metal piece, etc., and dried, and then pressed to form an electrode. Examples of the conductive auxiliary include acetylene black, examples of the binder include various resins, or fluororesin etc. to be more specific, and examples of the solvent include n-methyl-2-pyrrolidone. A lithium ion secondary battery can be constituted by the electrodes thus obtained, electrolyte solution containing lithium salt, separator, and the like.

### EXAMPLES

The present invention is explained more specifically using examples. It should be noted, however, that the present invention is not limited to the embodiments described in these examples. First, how the samples obtained by the examples/comparative examples were analyzed and evaluated is explained.

(How to Measure D50, D100, etc.)

D50 and D100 are particle size indicators based on cumulative frequency by laser diffraction measurement of particle size distribution. D50 represents the particle size when the cumulative frequency as counted from the smallest particle size reaches 50%, while D100 represents the particle size when the cumulative frequency reaches 100%. The Microtrack HRA9320-X100 by Nikkiso was used as a measurement apparatus, ethanol was used as a dispersion medium, and samples were dispersed by supersonic waves for 3 minutes using a supersonic homogenizer as a pretreatment.

(Measurement of Specific Surface Area)

The specific surface area was measured using the FlowSorb 11-2300 by Shimadzu.

(Measurement of Angle of Repose)

The angle of repose was measured according to JIS R9301-2-2: 1999.

(Battery Evaluation—Half Cell)

The figure is a schematic section view of a half cell. An electrode mixture was prepared by using lithium-titanium complex oxide as an active material. Ninety parts by weight of the obtained lithium-titanium complex oxide as an active material, 5 parts by weight of acetylene black as a conductive auxiliary, and 5 parts by weight of polyvinylidene difluoride (PVdF) as a binder, were mixed using n-methyl-2-pyrrolidone (NMP) as a solvent. The materials were mixed using a high-shear mixer until a stable viscosity was obtained. The amount of NMP was adjusted so the viscosity of the mixed coating solution fell under a range of 500 to 1000 mPa·sec at 100 s⁻¹, and the amount required (weight ratio relative to 1 part by weight of solid content) was recorded. This electrode mixture 5 was applied to an aluminum foil 4 to a coating weight of 3 mg/cm² using the doctor blade method. The coated foil was vacuum-dried at 130° C., and then roll-pressed. The corresponding coating film density was calculated from the film thickness and coating weight, and recorded. The coating film was subjected to a peel test using a commercially available clear adhesive tape, with the test repeated five times at one location. The test results were classified into [symbol] (no peeling), ◯ (neither [symbol] nor ×) and × (peeling of 30% or more), and recorded. The coating film was also visually observed for smoothness and the results were classified into [symbol] (no visible surface irregularity or irregular surface pattern), ◯ (neither [symbol] nor ×) and × (3 or more surface irregularities or irregular surface pattern per 100 mm²), and recorded. An area of 10 cm² was stamped out from the coating film to obtain a positive electrode. For the negative electrode, a metal Li plate 6 attached to a Ni mesh 7 was used. For the electrolyte solution, ethylene carbonate and diethyl carbonate were mixed at a volume ratio of 1:2, and then 1 mol/L of LiPF₆ was dissolved into the obtained solvent. For a separator 9, a porous cellulose membrane was used. Also, as illustrated, Al leads 1, 8 were fixed using a thermo-compression bonding tape 2, and the Al lead 1 was fixed to the working electrode using a Kapton tape 3. An aluminum laminate cell 10 was thus prepared. This battery was used to measure the initial discharge capacity. The battery was charged to 1.0 V at a constant current of 0.105 mA/cm² (0.2 C) in current density, and then discharged to 3.0 V, with the cycle repeated three times and the discharge capacity in the third cycle used as the value of initial discharge capacity. Next, the rate characteristics were measured. Measurement was performed by increasing the charge/discharge rate in steps from 0.2 C to 1 C, 2 C, 3 C, 5 C and 10 C. The ratio of the discharge capacity at the 10-C rate in the second cycle, to the 0.2-C discharge capacity, was recorded as rate characteristics (%).

### Example 1

Into a 5-L pot, 728 g of a highly pure Anatase-type titanium dioxide of 10 m²/g in specific surface area (primary particle size of approx. 0.15 um) and 272 g of a reagent-grade lithium carbonate of 25 μm in average particle size were introduced and sealed together with 7 kg of zirconium beads of 10 mm in diameter, after which the mixture was agitated for 24 hours at 100 rpm and then separated from the beads to obtain a mixed powder. The mixed powder was filled in a saggar and heat-treated in a continuous sintering furnace in atmosphere under a profile of retaining the maximum temperature of 890° C. for 3 hours. Next, 700 g of this heat-treated powder was introduced to a batch bead mill filled with zirconium beads of 10 mm in diameter and crushed for 30 minutes, after which the crushed powder was passed twice through a pin mill of 250 mm in disk diameter operating at 7000 rpm. Thereafter, the powder was put through a grinding process for 10 minutes using an automatic grinder. When the powder was introduced to the batch bead mill and automatic grinder, ethanol was dripped by 0.5 percent by weight relative to the powder as an auxiliary. The obtained powder was filled in a saggar and heat-treated again in a continuous sintering furnace in atmosphere under a profile of retaining the maximum temperature of 585° C. for 3 hours, to obtain a lithium-titanium complex oxide.

### Examples 2, 3

A lithium-titanium complex oxide was prepared using the same method as in Example 1, except that the processing time in the automatic grinder was changed to 5 minutes (Example 2) and 20 minutes (Example 3), respectively.

### Examples 4 to 7

A lithium-titanium complex oxide was prepared using the same method as in Example 1, except that the maximum temperature in the second heat treatment was changed to 620° C. (Example 4), 570° C. (Example 5), 560° C. (Example 6) and 635° C. (Example 7), respectively.

### Examples 8 to 10

A lithium-titanium complex oxide was prepared using the same method as in Example 1, except that the processing time in the batch bead mill was changed to 45 minutes (Example 8), 12.5 minutes (Example 9) and 9 minutes (Example 10), respectively.

### Examples 11, 12

A lithium-titanium complex oxide was prepared using the same method as in Example 1, except that the maximum heat treatment temperature of the mixed powder of titanium dioxide and lithium carbonate was changed to 905° C. (Example 11) and 930° C. (Example 12), respectively.

### Comparative Examples 1, 2

A lithium-titanium complex oxide was prepared using the same method as in Example 1, except that the processing time in the automatic grinder was changed to 2 minutes (Comparative Example 1) and 30 minutes (Comparative Example 2), respectively.

### Comparative Examples 3, 4

A lithium-titanium complex oxide was prepared using the same method as in Example 1, except that the maximum temperature of the second heat treatment was changed to 550° C. (Comparative Example 3) and 650° C. (Comparative Example 4), respectively.

### Comparative Example 5

A lithium-titanium complex oxide was prepared using the same method as in Example 1, except that the maximum heat treatment temperature of the mixed powder of titanium dioxide and lithium carbonate was changed to 980° C.

### Comparative Example 6

A lithium-titanium complex oxide was prepared using the same method as in Example 1, except that the processing time in the batch bead mill was changed to 5 minutes.

### Comparative Examples 7, 8

A lithium-titanium complex oxide was prepared using the same method as in Comparative Example 6, except that the processing time in the automatic grinder was changed to 5 minutes (Comparative Example 7) and 20 minutes (Comparative Example 8), respectively.

### Comparative Example 9

A lithium-titanium complex oxide was prepared using the same method as in Example 1, except that the processing time in the bead mill was changed to 40 minutes, and polyethylene glycol was used instead of ethanol as an auxiliary when the powder was crushed in the bead mill and in the automatic grinder. The evaluation results of examples and comparative examples are summarized in Tables 1 and 2.

TABLE 1

| | Specific surface area | | | | | | |
|---|---|---|---|---|---|---|---|
| | After heat | After | | Particle size distribution | | | |
| | treatment | crushing | Final | D50 | D100 | At least | Angle of |
| | m²/g | m²/g | m²/g | μm | μm | twice D50 | repose ° |
| Example 1 | 2.5 | 13.0 | 10.0 | 1.3 | 14 | 20% | 40 |
| Example 2 | 2.5 | 13.0 | 9.7 | 1.2 | 14 | 24% | 39 |
| Example 3 | 2.5 | 13.0 | 10.2 | 1.3 | 14 | 17% | 42 |
| Example 4 | 2.5 | 13.0 | 8.4 | 1.4 | 15 | 22% | 41 |
| Example 5 | 2.5 | 13.0 | 11.5 | 1.2 | 14 | 19% | 40 |
| Example 6 | 2.5 | 13.0 | 12.2 | 1.1 | 12 | 17% | 40 |
| Example 7 | 2.5 | 13.0 | 7.5 | 1.5 | 15 | 24% | 41 |
| Example 8 | 2.5 | 15.0 | 11.8 | 1.1 | 8 | 19% | 37 |
| Example 9 | 2.5 | 10.0 | 7.3 | 1.4 | 16 | 20% | 44 |
| Example 10 | 2.5 | 8.6 | 5.9 | 1.5 | 15 | 21% | 47 |
| Example 11 | 2.0 | 12.0 | 8.6 | 1.4 | 14 | 18% | 41 |
| Example 12 | 1.3 | 8.5 | 7.8 | 1.5 | 12 | 16% | 42 |
| Comparative Example 1 | 2.5 | 13.0 | 9.4 | 1.3 | 19 | 26% | 35 |
| Comparative Example 2 | 2.5 | 13.0 | 10.4 | 1.2 | 12 | 14% | 44 |
| Comparative Example 3 | 2.5 | 13.0 | 12.8 | 1.0 | 11 | 15% | 37 |
| Comparative Example 4 | 2.5 | 13.0 | 6.6 | 1.6 | 14 | 26% | 47 |
| Comparative Example 5 | 0.8 | 9.0 | 7.5 | 1.6 | 9 | 12% | 44 |
| Comparative Example 6 | 2.5 | 7.1 | 5.3 | 1.6 | 17 | 20% | 48 |
| Comparative Example 7 | 2.5 | 7.1 | 4.9 | 1.6 | 17 | 24% | 46 |
| Comparative Example 8 | 2.5 | 7.1 | 5.6 | 1.7 | 14 | 16% | 50 |
| Comparative Example 9 | 2.5 | 12.2 | 8.9 | 1.4 | 29 | 22% | 39 |

TABLE 2

| | | Coating | | | 0.2-C | 10-C | | |
|---|---|---|---|---|---|---|---|---|
| | NMP/ | film | | | discharge | discharge | 10-C/0.2-C | |
| | solid | density | Peel | | capacity | capacity | capacity | Final |
| | content | g/cm³ | test | Smoothness | mAhr/g | mAhr/g | ratio | judgment |
| Example 1 | 0.78 | 2.3 | [symbol] | [symbol] | 167 | 157 | 94 | [symbol] |
| Example 2 | 0.73 | 2.3 | [symbol] | [symbol] | 165 | 153 | 93 | [symbol] |
| Example 3 | 0.84 | 2.2 | [symbol] | [symbol] | 165 | 155 | 94 | [symbol] |
| Example 4 | 0.77 | 2.2 | [symbol] | [symbol] | 166 | 153 | 92 | [symbol] |
| Example 5 | 0.91 | 2.0 | [symbol] | [symbol] | 163 | 153 | 94 | [symbol] |
| Example 6 | 1.04 | 1.9 | ◯ | [symbol] | 162 | 133 | 82 | ◯ |
| Example 7 | 0.76 | 2.1 | [symbol] | ◯ | 165 | 145 | 88 | ◯ |
| Example 8 | 0.9 | 2.1 | [symbol] | [symbol] | 164 | 154 | 94 | [symbol] |
| Example 9 | 0.77 | 2.2 | [symbol] | [symbol] | 166 | 148 | 89 | [symbol] |
| Example 10 | 0.77 | 2.1 | [symbol] | [symbol] | 167 | 125 | 75 | ◯ |
| Example 11 | 0.85 | 2.1 | [symbol] | [symbol] | 164 | 141 | 86 | [symbol] |
| Example 12 | 0.91 | 2.2 | [symbol] | [symbol] | 166 | 129 | 78 | ◯ |
| Comparative | 0.73 | 1.9 | ◯ | ◯ | 159 | 146 | 92 | X |
| Example 1 | | | | | | | | |
| Comparative | 0.95 | 1.8 | X | [symbol] | 159 | 145 | 91 | X |
| Example 2 | | | | | | | | |
| Comparative | 1.13 | 1.7 | ◯ | ◯ | 158 | 123 | 78 | X |
| Example 3 | | | | | | | | |
| Comparative | 0.74 | 1.8 | ◯ | ◯ | 160 | 99 | 62 | X |
| Example 4 | | | | | | | | |
| Comparative | 0.93 | 1.9 | ◯ | [symbol] | 167 | 100 | 60 | X |
| Example 5 | | | | | | | | |
| Comparative | 0.76 | 2.0 | ◯ | ◯ | 161 | 98 | 61 | X |
| Example 6 | | | | | | | | |
| Comparative | 0.74 | 2.1 | ◯ | X | 158 | 95 | 60 | X |
| Example 7 | | | | | | | | |
| Comparative | 0.83 | 1.9 | X | ◯ | 159 | 97 | 61 | X |
| Example 8 | | | | | | | | |
| Comparative | 0.71 | 1.6 | X | X | 158 | 100 | 63 | X |
| Example 9 | | | | | | | | |

The above results show that a lithium ion secondary battery containing the lithium-titanium complex oxide proposed by the present invention as an electrode active material offers high initial discharge capacity, excellent rate characteristics and smooth electrodes.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, an article “a” may refer to a species or a genus including multiple species, and “the invention” or “the present invention” may refer to at least one of the embodiments or aspects explicitly, necessarily, or inherently disclosed herein. In this disclosure, any defined meanings do not necessarily exclude ordinary and customary meanings in some embodiments.

The present application claims priority to Japanese Patent Application No. 2011-235219, filed Oct. 26, 2011, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A lithium-titanium complex oxide whose particle size distribution as measured by the laser diffraction method satisfies (a), (b) and (c) below:
(a) The average particle size D50 is 1.0 to 1.5 μm;
(b) The total frequency of particles whose particle size is greater than twice the average particle size D50 is 16 to 25%;
(c) The maximum particle size (D100) is 20 μm or less.

2. A lithium-titanium complex oxide according to claim 1, whose specific surface area as measured by the BET method is 6 to 14 m²/g.

3. A lithium-titanium complex oxide according to claim 1, whose angle of repose is 35 to 50°.

4. A lithium-titanium complex oxide according to claim 2, whose angle of repose is 35 to 50°.

5. A positive electrode for a battery containing the lithium-titanium complex oxide according to claim 1 as a positive electrode active material.

6. A positive electrode for a battery containing the lithium-titanium complex oxide according to claim 2 as a positive electrode active material.

7. A positive electrode for a battery containing the lithium-titanium complex oxide according to claim 3 as a positive electrode active material.

8. A positive electrode for a battery containing the lithium-titanium complex oxide according to claim 4 as a positive electrode active material.

9. A negative electrode for a battery containing the lithium-titanium complex oxide according to claim 1 as a negative electrode active material.

10. A negative electrode for a battery containing the lithium-titanium complex oxide according to claim 2 as a negative electrode active material.

11. A negative electrode for a battery containing the lithium-titanium complex oxide according to claim 3 as a negative electrode active material.

12. A negative electrode for a battery containing the lithium-titanium complex oxide according to claim 4 as a negative electrode active material.

13. A lithium ion secondary battery having a positive electrode containing the lithium-titanium complex oxide according to claim 1 as a positive electrode active material, or a negative electrode containing the lithium-titanium complex oxide according to claim 1 as a negative electrode active material.

14. A manufacturing method of lithium-titanium complex oxide whereby a mixture of titanium compound and lithium compound is heat-treated at 700° C. or above to obtain a lithium-titanium complex oxide, after which 100 parts by weight of the obtained lithium-titanium complex oxide is crushed in the presence of 10 parts by weight or less of a dispersion medium to increase the specific surface area of the lithium-titanium complex oxide by 5.0 m²/g or more.

15. A manufacturing method according to claim 14, whereby the specific surface area of the lithium-titanium complex oxide is decreased by 0.5 to 6.0 m²/g by applying heat treatment again after the crushing process.
